(19) United States
(12) Patent Application Publication
(10) Pub. No.: US 2009/0123265 A1
(43) Pub. Date: May 14, 2009

(54) Gas Turbine Engine

(76) Inventor: Kevork Nercessian, Seefeld (DE)

Correspondence Address: QUARLES & BRADY LLP, 411 E. WISCONSIN AVENUE, SUITE 2040, MILWAUKEE, WI, 53202-4497, US

(21) Appl. No.: 12/265,591

(22) Filed: Nov. 5, 2008

Related U.S. Application Data
(63) Continuation-in-part of application No. 12/124,828, filed on May 21, 2008, now abandoned.

(30) Foreign Application Priority Data
Aug. 2, 2007 (EP) 07015217.8

(51) Int. Cl. F02C 3/067; F02C 9/20; B23P 11/00

(52) U.S. Cl. 415/62; 415/129; 29/889.21

(57) ABSTRACT

The invention is directed to a gas turbine engine comprising a compressor, a combustion chamber, and a turbine section installed one after the other in series in the direction of the air and gas flow, wherein the compressor consists of two groups of blade wheels rotating in opposite directions to each other. The deviation of the performance defined as “air mass flow per second” between both compressor groups is minimized and a detachment of the air mass flow from the blades is substantially eliminated. The blade wheels of the second compressor group, beginning at the first blade wheel, are progressively bigger to allow a bypass for the air stream coming from the first compressor group to serve all the blade wheels of the second group essentially simultaneously.

### CROSS REFERENCES TO RELATED APPLICATIONS

This application is a continuation-in-part of U.S. patent application Ser. No. 12/124,828 filed May 21, 2008 that claimed priority from European Patent Application 07015217.8 filed Aug. 2, 2007, which is hereby incorporated by reference as if fully set forth herein.

### STATEMENT REGARDING FEDERALLY SPONSORED RESEARCH

Not applicable.

### BACKGROUND OF THE INVENTION

The invention is directed to gas turbine engines that are a particular form of a combustion engine comprising mainly a compressor, a combustion chamber, and a turbine installed one after the other in the direction of the air and gas flow. In general, the turbine withdraws from the hot stream of gases coming out of the combustion chamber the energy needed to drive the compressor by means of a shaft. By this operation the pressure of the gas stream is reduced approximately by the amount corresponding to the energy withdrawn from the turbine for the compressor.

The two main applications of a gas turbine engines are:

1. A gas turbine engine in which the hot gas stream transmits its total energy to one or more turbine groups. With a part of the energy the turbine serves the compressor. The rest of the energy drives, generally by means of a shaft, an external device such as a generator of electricity, a propeller of an aircraft or big ship, a rotor, a hovercraft, a heavy engine or locomotive, and other devices like pumps. By this application the gas turbine engines are commonly called as gas turbine. The designation “gas turbine” will be used in the following for this kind of gas turbine engine.
2. A gas turbine engine in which the remaining gases, after serving the first group of the turbine, stream out of the engine for the propulsion of an aircraft. In this application the gas turbine engine is commonly called a jet engine or an aero turbo engine. The designation “aero turbo engine” will be used in the following for this kind of gas turbine engine.

Since the creation of the gas turbine engine about fifty-five years ago, the main principle of the operation remained the same. It goes without saying that several improvements took place on these conventional gas turbine engines. None of those improvements however brought a basic modification in the construction of gas turbine engines that could update the actual technology to a new generation of gas turbine engines.

The turbines and compressors of gas turbine engines today at the actual technical level have at least the following disadvantages:
For the construction of a gas turbine engine with an acceptable output of air mass flow per second from the compressor, the blade wheels of the compressor must have a big size and have a great number of blade wheels.
Conventional compressors have big dimensions and more weight.
For the construction of a gas turbine engine with an acceptable withdrawal of energy from the hot gases, the turbine blade wheels must have a big size and have a great number of turbine blade wheels.
Conventional turbines have big dimensions and more weight.
For the numerous blade wheels needed for the turbine and compressor sections, the gas turbine unit of the conventional gas turbine engine is too big and too heavy.
The actual compressors of modern gas turbine engines, incorporating technology being fifty-five years old, consume a large quantity of energy for a targeted output of air mass flow per second (in the following referred to as air mass flow/s). The large quantity of energy consumed from the compressor results in a significant amount of more fuel consumption.

### SUMMARY OF THE INVENTION

Since fuel is a combustible resource, which is becoming rarer in this world, the fuel prices are getting higher and the fuel consumption is playing a bigger economical role in the choice of gas turbine engines.

The dimensions and especially the weights of conventional gas turbine engines, particularly aero turbo engines, have arrived at a limit that does not allow any significant amelioration for better performance without raising the weight of an engine. An installation of heavier engines brings problems especially for the design and construction of earth bound vehicles, water vehicles, and aircrafts.

The importance of less weight and less fuel consumption for gas turbine engines has created the necessity to find a solution allowing the compressor to produce a higher performance of air mass flow/s with less fuel consumption and less weight. Therefore, in one aspect, the invention may provide a gas turbine engine having less weight and less fuel consumption compared to conventional gas turbine engines.

According to another aspect of the invention, a targeted performance of a gas turbine engine may be realized by approximately two-thirds of the weight of a modern gas turbine engine. This characteristic of the weight is highly appreciated by the producers of aero turbo engines and producers of aircrafts.

The total performance of a gas turbine engine is proportional to the air mass flow/s produced by the compressor. Another aspect of the invention may allow the compressor to produce approximately 100% more air mass flow/s than a conventional compressor by the same withdrawal of energy from the turbine. In other words, a compressor according to this aspect of the invention may consume approximately half the energy of a conventional compressor with the result of approximately 33% less fuel consumption for a targeted thrust of a gas turbine engine.

Applied Technologies

In accordance with yet another aspect of the invention, the higher performance of the compressor may be realized by (a) using the theory of two substantially identical blade wheels rotating at generally the same rotational speed in opposite directions to each other realizing approximately 60 to 140% more air mass flow than two substantially identical blade wheels rotating in the same direction, and (b) by applying the theory of two substantially identical blade wheels rotating in opposite directions to each other to two groups of blade wheels of a compressor rotating in opposite directions to each other.

Chart No. 1 (shown in FIG. 7A) shows a vector diagram of two air streams AC and BC2 produced by two identical blade wheels rotating in one and the same direction. The sum of these two vectors is AC+BC2=AC1. From the sum of the total energy transmitted to both blade wheels—vector AC1—only the vector AB1 is effective. The radial vector B1C1 represents the vector producing the twisting movement of the air mass flow which causes the turbulences in the air mass flow without any participation in the effective air mass flow. The disadvantages of two blade wheels rotating in one direction by the same rotational speed include (a) loss of energy through undesirable twisting air mass flow and (b) presence of undesirable turbulences in the air mass flow.

From the original energy transmitted from the compressor to the air mass flow represented by the vectors AC and BC2 only the axial vectors AB and BB1 are effective and can be used.

Chart No. 2 (shown in FIG. 7B) shows the vectors of two equal helicoidal air streams AC and AC1 for two identical blade wheels rotating in opposite directions to each other. The components of the helicoidal vectors are:

AC=AB+BC

AC1=AB+BC1

The radial components BC and BC1, being equal and in opposite directions to each other, eliminate each other by straightening the full length of the helicoidal vectors AC and AC1. By the absence of the radial components there will be essentially no loss of energy due to undesirable rotational movements in the air mass flow and the resulting air mass flow will be substantially totally axial and generally free from turbulences and rotations.

The concept of two similar blade wheels rotating in opposite directions to each other turns many of the disadvantages caused by the helicoidal air flow resulting from the rotational movement of the blade wheels in one direction to the following beneficial results:
The air mass flow streaming out of the compressor section is substantially totally axial without any substantial turbulence.
The straightened vectors AC and AC1 are equal both to the axial vector AB2. For two blade wheels rotating in opposite directions to each other, the total effective axial vector is essentially twice the vector AB2 equaling the vector AB3 (instead of equaling the vector AB1).
The vector AB3 is approximately 2.4 times more (+140%) than the vector AB1 that is the sum of the effective axial vectors AB+BB1 of two identical blade wheels rotating in one direction.

Different efficiencies may be obtained by different angles between the helicoidal air mass flow and the axle of the blade wheels as outlined in the following.

In the chart No. 3 (shown in FIG. 7C) three helicoidal vectors AA1, AX, and AB represent three different main vectors of air mass flow in the compressor. The angles between the helicoidal vectors of the air mass flow and the axial vector are chosen differently. By higher angles, the length of the main helicoidal vector is longer referring to the same effective axial flow.

The axial vector AC is the useful effective vector for all three vectors AB, AX, and AA1, which represent the energy transmitted from the compressor to the air mass flow.

Chart No. 3 (shown in FIG. 7C) shows that by higher angles of the helicoidal vectors, the energy given to the air mass flow for a certain effective or useful axial flow is higher than the energy given to the air mass flow by a lower angle of the helicoidal vector. This phenomenon illustrates that this particular aspect of the invention is even more effective at higher angles of the helicoidal vectors because the full length of the helicoidal vector, which is longer at higher angles, will be straightened to a useful and effective axial vector.

In accordance with one aspect of the invention, all three vectors can be straightened in their full lengths. A straightened vector AA1 will turn to an axial vector AC1 with a length of 1.6 times the original axial vector AC, a straightened vector AX will turn to an axial vector AY that is twice the original axial vector AC, and a straightened vector AB will turn to an axial vector AC2 that is 2.4 times the original axial vector AC.

Tendency of Detachment of the Air Mass Flow

Tests in several laboratories demonstrated that the theory of two substantially identical blade wheels rotating in opposite directions to each other cannot be applied with the same results to two groups of blade wheels rotating in opposite directions to each other.

By a compressor comprising two groups of four essentially identical blade wheels each, all the blade wheels of both groups being substantially identical, the air mass flow and the pressure produced by the first group is four times higher than the air mass flow and the pressure produced by only one blade wheel. The total air mass flow of the first group of the compressor leaves the first group of the compressor to encounter the second group of the compressor by its first blade wheel rotating in an opposite direction.

The first blade wheel of the second group of the compressor produces a helicoidal air mass flow and a pressure of only one blade wheel in an opposite direction. It does not have enough energy to face and withstand a helicoidal air mass flow which is four times stronger, nor to eliminate a part of the radial component. The air mass flow coming from the first group of the compressor overruns the air mass flow of the first blade wheel of the second group by detaching the air mass from its blades.

Chart No. 4 (shown in FIG. 7D) shows the vector AA4 that is the sum of the four vectors of the four blade wheels of the first group of the compressor. The radial component of the vector AA4 is the vector EA4.

The vector of the air mass flow of the first blade wheel of the second group of the compressor is represented by the vector EE1. The radial component of the vector EE1 is the vector EEO.

The radial vector EA4 being four times stronger and in an opposite direction to the vector EEO overruns the radial vector EEO by detaching the air mass flow of the vector EE1 from the blades of the first blade wheel in the second group of the compressor.

Aspects of the Invention

The realization of the target of the present invention is mainly effectuated by:

(a) Using the theory of two similar blade wheels rotating in opposite directions to each other by the same approximate rotational speed.

(b) Reducing the problem of the detachment by allowing the first group of the compressor to serve all the blade wheels of the second group of the compressor essentially simultaneously.

For this purpose, the first blade wheel of the second group of the compressor has a smaller diameter and subsequent blade wheels have progressively increased diameters (FIG. 3). The progressively increased diameters create a bypass between the blade wheels and the inner wall of the compressor that allows the air mass flow coming from the first group of the compressor to serve all the blade wheels of the second groups of the compressor substantially simultaneously.

Chart No. 5 (shown in FIG. 7E) shows the sum of four vectors of the first group of the compressor AA4 with its radial component EA4. The sum of the radial vectors of the five blade wheels of the second group of the compressor is EE5. The radial vectors EA4 and EE5 being equal and in opposite direction to each other substantially eliminate each other.

(c) Designing approximately equal performances for both groups of the blade wheels of the compressor. For the calculation of the performances of the blade wheels, the following formula can be used, which does not consider the small higher pressure of the second group of the compressor. Small higher pressure results in a small higher performance:

Air mass flow = (diameter of the blade wheel)³
Performance of group 1 (see FIG. 4):

| | | |
|---|---|---|
| 4 × (7 × 7)³ = | 1372 | units |

Performance of group 2 (see FIG. 4):

| | | |
|---|---|---|
| 1 × (7 × 7)³ = | 343 | |
| 1 × (6.6 × 6.6)³ = | 287 | |
| 1 × (6.4 × 6.4)³ = | 262 | |
| 1 × (6.2 × 6.2)³ = | 238 | |
| 1 × (6 × 6)³ = | 216 | |
| = | 1346 | units |

The small differences between the first group of the compressor and the second group of the compressor (i.e., 1372−1346=26 units) will be compensated through a slightly increased performance due to a higher pressure of the air mass flow in the second compressor group and through adjustments of the angles of the blades of the blade wheels.

Operational Description

The quantity of the air mass flow streaming through the bypass to each of the different blade wheels of the second compressor group (see FIG. 4) will be regulated automatically through the performances calculated for each of the blade wheels. By the same rotational speed, every blade wheel has a certain capacity to compress a certain amount of air mass flow. It cannot compress more and if there is not enough air mass to compress it creates a vacuum in front of the blade wheel. The vacuum will attract and swallow the air mass that is present next to it.

The property of the blade wheels to be able to compress only a certain calculated air mass flow, but create a vacuum when a certain air mass flow is not present to be compressed, gives the possibility to all the blade wheels of the second compressor group to serve themselves with the air mass flow coming from the first compressor group substantially simultaneously.

In this manner, the radial component of the helicoidal air mass flow produced in the first compressor group will be essentially completely eliminated through the partial radial components of the blade wheels of the second compressor group (see chart No. 5 as shown in FIG. 7E).

The many aspects of the invention include without limitation:
The compressor according to an aspect of the invention produces more air mass flow/s entering the combustion chamber, thus realizing more fuel to burn.
According to another aspect of the invention, a gas turbine engine produces approximately 33% more energy by the same weight of a conventional gas turbine engine.
The compressor of a gas turbine engine according to a further aspect of the invention needs approximately 33% less energy for the same performance of a conventional gas turbine engine with the result of approximately 33% less fuel consumption.
Moreover, approximately 33% less fuel consumption results in approximately 33% less gas emission.
According to another aspect of the invention, an air mass flow streaming into the combustion chamber with substantially reduced turbulences realizes a better ignition and burning of the fuel with the result of less fuel consumption for a certain performance.
In another aspect, the compressor produces a higher performance that overcomes more easily the static pressure, which in other words is the inner resistance of the gas turbine engine.
Contrary to an engine according to the present invention, a rotation of all the blade wheels in one direction causes a one-sided stress to all the moving components of the engine.
According to another aspect of the invention, a steeper angle between the helicoidal air mass flow and the axle of the compressor allows even higher performances of the compressor.
In yet a further aspect, with the help of a new designed bypass, the first compressor group serves all the blade wheels of the second compressor group essentially simultaneously to substantially eliminate the tendency of detachment of the air mass from the blades of the first blade wheel of the second compressor group.
In another aspect, a targeted performance of energy may be realized by smaller dimensions and less weight.
In yet a further aspect, the contribution of substantially all of the mentioned characteristics results generally in a lower fuel consumption, in a lower emission of gases, less weight, in a lower noise, and less vibrations of the engine.

In the accompanying drawings, preferred embodiments of the present invention are described in detail. The drawings are not to be understood as limiting the invention to only the illustrated and described examples as to how the invention can be used and presented. Further features and aspects will become apparent from the following and particular description of the invention, which is illustrated in the accompanying drawings.

### BRIEF DESCRIPTION OF THE DRAWINGS

FIG. 1 is a simplified cross-section showing a conventional gas turbine engine comprising a compressor 1, a combustion chamber 2, a turbine 3, and two shafts 4 and 5;

FIG. 1a is a simplified cross-section showing a second application of a conventional gas turbine engine comprising a compressor 1, a combustion chamber 2, a turbine 3, and an outlet 4 for the hot stream of gases;

FIG. 2 is a simplified cross-section of a first embodiment according to an aspect of the invention that shows an aero turbo engine comprising two groups of a compressor 131 and 135 rotating in opposite directions to each other with the help of a reverse mechanism 100 installed between both groups of the compressor 131 and 135, a combustion chamber 2, and a conventional turbine 149 with two blade wheels 151 and 152;

FIG. 3 is a simplified cross-section of a second embodiment according to an aspect of the invention that shows an aero turbo engine with two groups of a compressor 10 and 20, a combustion chamber 30, a turbine section 45 comprising a first group of the turbine 40, an axial converter 50, and a second group of the turbine 60 (both groups of the turbine 40 and 60 are connected to both groups of the compressor 20 and 10 by means of two concentric shafts 170);

FIG. 4 is a simplified cross-section of a third embodiment according to an aspect of the invention that shows an aero turbo engine with two groups of a compressor 131 and 135, a combustion chamber 2, a turbine section 149 comprising a first group of the turbine 151 with shorter blades, an axial converter 190, and a second group of the turbine 152—the first group of the turbine 151 together with the axial converter 190 are covered with a steel tube 191—both groups of the turbine 151 and 152 are connected to both groups of the compressor 131 and 135 by two concentric shafts 170;

FIG. 5a is a simplified front elevation view showing an exemplary axial converter 190 that may be installed between both groups of a turbine to straighten the helicoidal air mass flow coming out of the first group of the turbine;

FIG. 5b is a simplified side elevation view of the axial converter 190 shown in FIG. 5a;

FIG. 6 is a perspective view of an aspect of the invention showing two concentric shafts that connect both groups of the turbine to both groups of the compressor; and

FIGS. 7A-7E depict chart Nos. 1 to 5 showing exemplary vectorial components of the air mass flow in the compressor section of a gas turbine engine.

### DETAILED DESCRIPTION OF THE PREFERRED EXAMPLE EMBODIMENTS

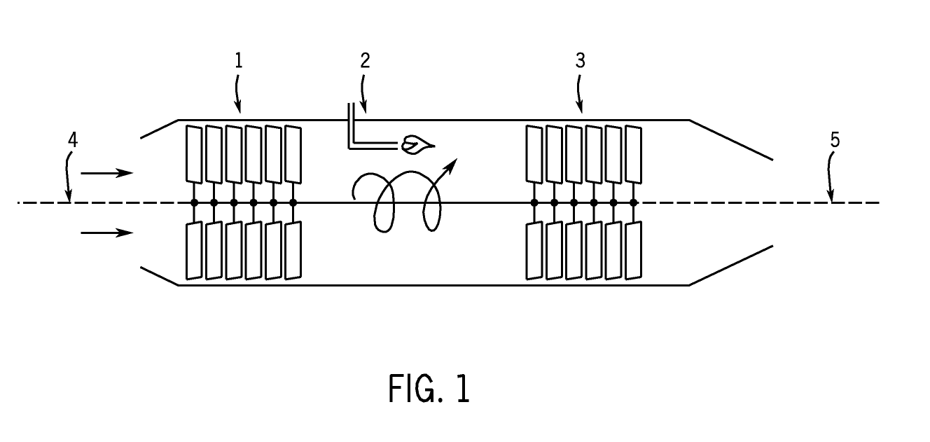

With initial reference to FIG. 1, FIG. 1 shows the principle of a conventional gas turbine that consists mainly of a compressor 1, a combustion chamber 2, a turbine 3, and a shaft 4, 5. The turbine 3 withdraws substantially all of the energy from the hot gases streaming out of the combustion chamber 2. A part of this energy serves to drive the compressor 1. The rest of the energy may be transmitted to an external device by means of the shaft 4, 5.

Turning to FIG. 1a, FIG. 1a shows another application of a conventional gas turbine engine which is an aero turbo engine comprising mainly a compressor 1, a combustion chamber 2, a turbine 3, and an outlet 4. The turbine 3 withdraws from the hot gases streaming out of the combustion chamber 2 the energy required to drive the compressor 1 by means of a shaft 6. The rest of the hot gases streams out of the outlet 4 for the propulsion of an aircraft and the like.

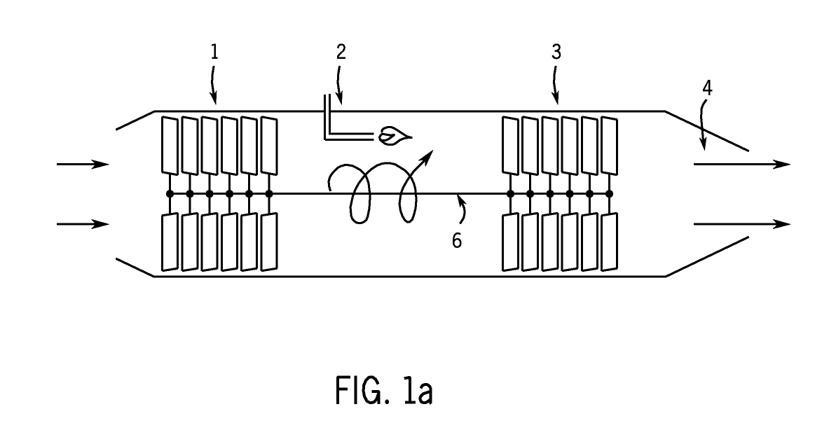

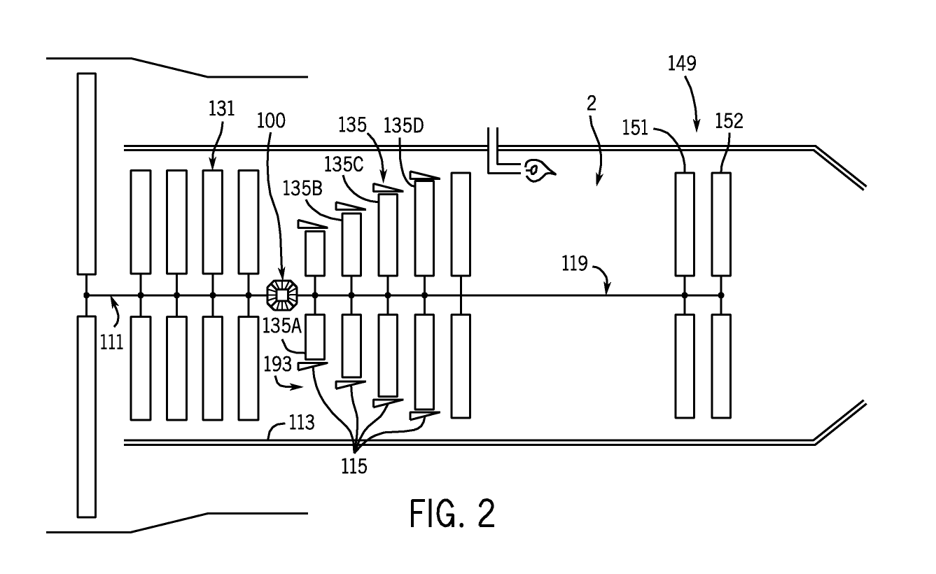

With specific reference to FIG. 2, FIG. 2 shows a first embodiment (i.e., design No. 1) according to an aspect of the invention that allows both groups of the compressor 131, 135 to rotate in opposite directions to each other with the help of a reverse mechanism 100. A shaft 119 connects the turbine 149 to the second group of the compressor 135 and to the reverse mechanism 100. A second shaft 111 connects the other side of the reverse mechanism 100 to the first group of the compressor 131. The turbine 149 withdraws from the hot gases streaming out of the combustion chamber 2 the energy required so that both groups of the compressor 131, 135 rotate in opposite directions to each other by approximately the same performance.

The performance of each group of the compressor 131, 135 can be calculated roughly by adding the partial performances of the blade wheels in each group 131, 135. The partial performance of a blade wheel can be calculated with the following formula:

Air mass flow=(diameter of the blade wheel)³

For example, in FIG. 2, four blade wheels have each a diameter of 7 units. The performance of the first group of the compressor is:

4×(7×7)³=1372 units.

The performance of the second group of the compressor is:

1×(6×6)³=216

1×(6.2×6.2)³=238

1×(6.4×6.4)³=262

1×(6.6×6.6)³=287

1×(7×7)³=343

Total performance: 1346 units

The difference of performances between the first group 131 and the second group 135 of the compressor (1.372−1.346=26 units) will be compensated through a slightly increased performance due to a higher pressure of the air mass flow in the second compressor group 135 and additionally through adjustments of the angles of the blades of all the blade wheels in the compressor section.

The first blade wheel 135A of the second group 135 of the compressor is designed by a smaller size and the next three blade wheels 135B, 135C, 135D by progressively increased diameters, thus creating a bypass 193 between the blade wheels of the second group of the compressor 135 and the inner wall 113 of the compressor. This bypass 193 allows the air mass flow coming from the first group of the compressor 131 to serve all the blade wheels of the second group of the compressor 135 substantially simultaneously, thus essentially eliminating the possibility of a detachment of the air mass flow from the blades of the first blade wheel 135A of the second group of the compressor 135.

Four conical rings 115 cover the shorter designed blade wheels of the second group of the compressor 135 to allow higher pressures and a better distribution of the air mass among the blade wheels of the second group of the compressor 135.

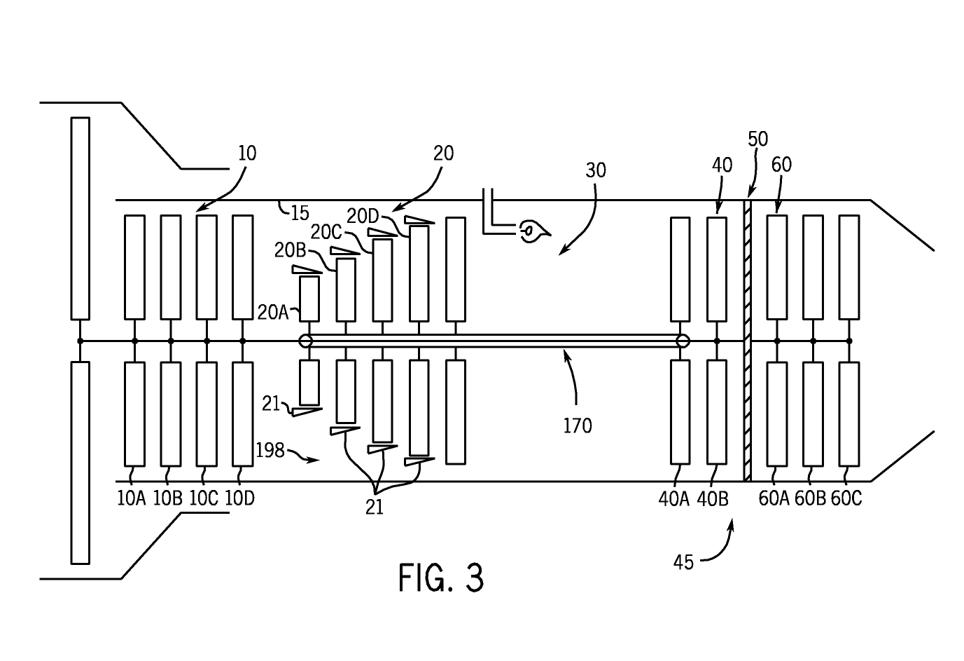

With reference to FIG. 3, FIG. 3 shows a second embodiment (i.e., design No. 2) according to another aspect of the invention that allows both groups of the compressor 10, 20 to rotate in opposite directions to each other with the help of two concentric shafts 170.

The turbine section 45 consists of a first group of the turbine 40, an axial converter 50, and a second group of the turbine 60 installed one after the other in the direction of the gas flow. The gas flow streaming out of the combustion chamber 30 makes the first group of the turbine 40 rotate in one direction. A helicoidal gas flow streams out of the first group of the turbine 40 into an axial converter 50 that straightens the helicoidal gas flow coming out of the first group of the turbine 40. Only a substantially axial flow of a gas can make the second group of the turbine 60 rotate in an opposite direction to the first group of the turbine 40.

The two concentric shafts 170 connect the first group of the turbine 40 to the second group of the compressor 20 and the second group of the turbine 60 to the first group of the compressor 10. Both groups of the turbine 40, 60 withdraw from the hot stream of gases the energy required for both groups of the compressor 10, 20 to rotate in opposite directions to each other by approximately the same performance or air mass flow.

The first group of the turbine 40 comprises two blade wheels 40A, 40B and the second group of the turbine 60 comprises three blade wheels 60A, 60B, 60C. Due to a higher pressure of the hot stream of gases serving the first group of the turbine 40 and due to a slight weakening of the pressure of the hot stream of gases by passing through the axial converter 50, the withdrawal of energy from the hot stream of gases from both groups 40 and 60 of the turbine is nearly equal. Small deviations could be eliminated by adjustments of the angles of the blade wheels of the turbine.

The performance of each group of the compressor 10, 20 can be calculated roughly by adding the partial performances of the blade wheels in each group. The partial performance of the blade wheel can be calculated with the following formula:

Air mass flow=(diameter of the blade wheel)³

For example, in FIG. 3 the first group of the compressor 10 comprises four blade wheels 10A, 10B, 10C, 10D having each a diameter of 7 units. The performance of the first group of the compressor 10 is:

4×(7×7)³=1372 units

The performance of the second group of the compressor 2 is:

1×(6×6)³=216

1×(6.2×6.2)³=238

1×(6.4×6.4)³=262

1×(6.6×6.6)³=287

1×(7×7)³=343

Total performance: 1346 units

The difference of performances between the first group 10 and the second group 20 of the compressor is:

1372−1346=26 units

These 26 units may be compensated through a slightly increased performance of the second group of the compressor 20 due to a higher pressure of the air mass flow in the group 20 of the compressor and additionally through adjustments of the angles of the blades of all the blade wheels in the compressor section.

The first blade wheel 20A of the second group of the compressor 20 is designed by a smaller size and the next three blade wheels 20B, 20C, 20D are designed by progressively increased diameters, thus creating a bypass 198 between the blade wheels of the second group of the compressor 20 and the inner wall 15 of the compressor. This bypass 198 allows the air mass flow coming from the first group of the compressor 10 to serve all the blade wheels of the second group of the compressor 20 essentially simultaneously, thus substantially eliminating the possibility of a detachment of the air mass flow from the blades of the first blade wheel 20A of the second group of the compressor 20.

Four conical rings 21 cover the shorter designed blade wheels of the second group of the compressor 20 to allow higher pressure and a better distribution of the air mass flow among the blade wheels of the second group of the compressor 20.

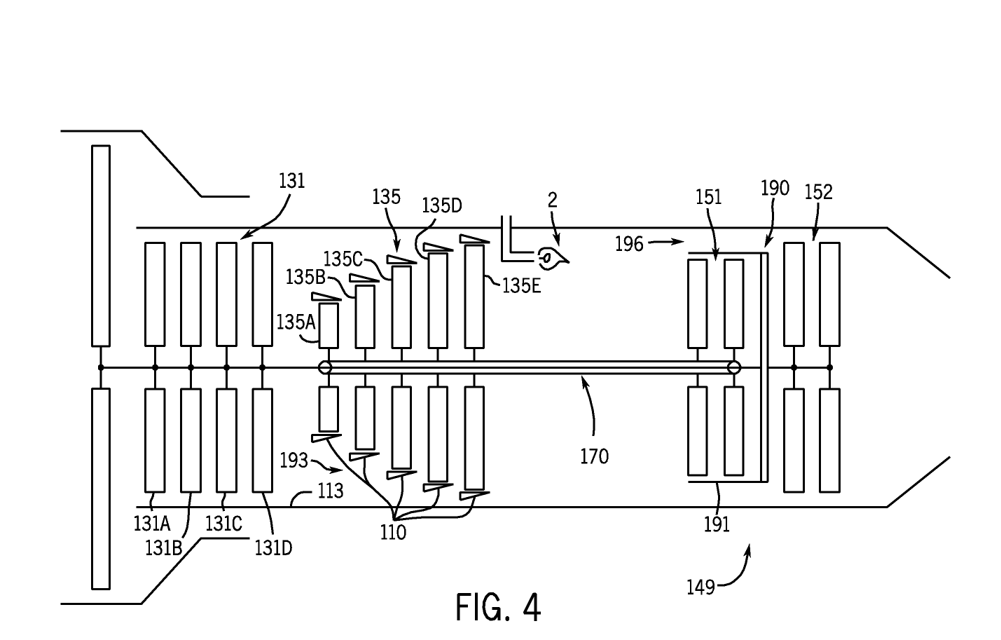

Turning to FIG. 4, FIG. 4 shows a third embodiment (i.e., design No. 3) according to another aspect of the invention that allows both groups of the compressor 131, 135 to rotate in opposite directions to each other by means of two concentric shafts 170.

The turbine section 149 consists of a first group of the turbine 151, an axial converter 190, and a second group of the turbine 152 installed one after the other in the direction of the gas flow.

The turbine section 149 consists of a first group of a turbine 151 with shorter blade wheels followed by an axial converter 190. The blade wheels of the first group of the turbine 151 together with the axial converter 190 are covered by a steel tube 191 that allows a better distribution of the gas flow between the first group of the turbine 151 and the bypass 196. The axial converter 190 substantially straightens the helicoidal gas flow coming from the blade wheels of the first group of the turbine 151. The second group of the turbine 152 is served partly by the straightened gas stream coming from the axial converter 190 and partly from the hot stream of gases coming directly from the combustion chamber 2 through the bypass 196.

Through the higher performance caused by a higher pressure of the gas stream passing through the first group of the turbine 151, the shorter blade wheels of the first group of the turbine 151 allow almost an equal withdrawal of energy from the hot stream of gases from both groups of the turbine 151, 152. Small deviations can be essentially eliminated by adjustments of the angles of the blades of the blade wheels of the turbine 149.

The two concentric shafts 170 connect the first group of the turbine 151 to the second group of the compressor 135 and the second group of the turbine 152 to the first group of the compressor 131. Both groups of the turbine 151, 152 withdraw from the hot stream of gases the energy required so that both groups of the compressor 131, 135 rotate in opposite directions to each other by approximately the same performance of air mass flow.

The performance of each group of the compressor 131, 135 can be calculated roughly by adding the partial performances of the blade wheels in each group. The partial performance of a blade wheel can be calculated with the following formula:

Air mass flow=(diameter of the blade wheel)³

For example, in FIG. 4 the first group of the compressor 131 comprises four blade wheels 131A, 131B, 131C, 131D having each a diameter of 7 units. The performance of the first group of the compressor is:

4×(7×7)³=1372 units

The performance of the second group of the compressor 135 comprising five blade wheels 135A, 135B, 135C, 135D, 135E is:

1×(6×6)³=216

1×(6.2×6.2)³=238

1×(6.4×6.4)³=262

1×(6.6×6.6)³=283

1×(7×7)³=343

Total performance: 1346 units

The difference of performances between the first group 131 and the second group 135 of the compressor is:

1372−1346=26 units

These 26 units will be compensated through a slightly increased performance of the second group of the compressor 135 due to a higher pressure of the air mass flow in the second group of the compressor 135 and additionally through adjustments of the angles of the blades of all the blade wheels in the compressor section.

The first blade wheel 135A of the second group of the compressor 135 is designed by a smaller size and the next four blade wheels 135B, 135C, 135D, 135E are designed by progressively increased diameters, thus creating a bypass 193 between the blade wheels of the second group of the compressor 135 and the inner wall 113 of the compressor. This bypass 193 allows the air mass flow coming from the first group of the compressor 131 to serve all the blade wheels of the second group of the compressor 135 substantially simultaneously, thus essentially eliminating the possibility of a detachment of the air mass flow from the blades of the first wheel blade of the second group of the compressor 135.

Five conical rings 110 cover the shorter designed blade wheels of the second group of the compressor 135 to allow higher pressure and a better distribution of the air mass flow among the blade wheels of the second group of the compressor 135.

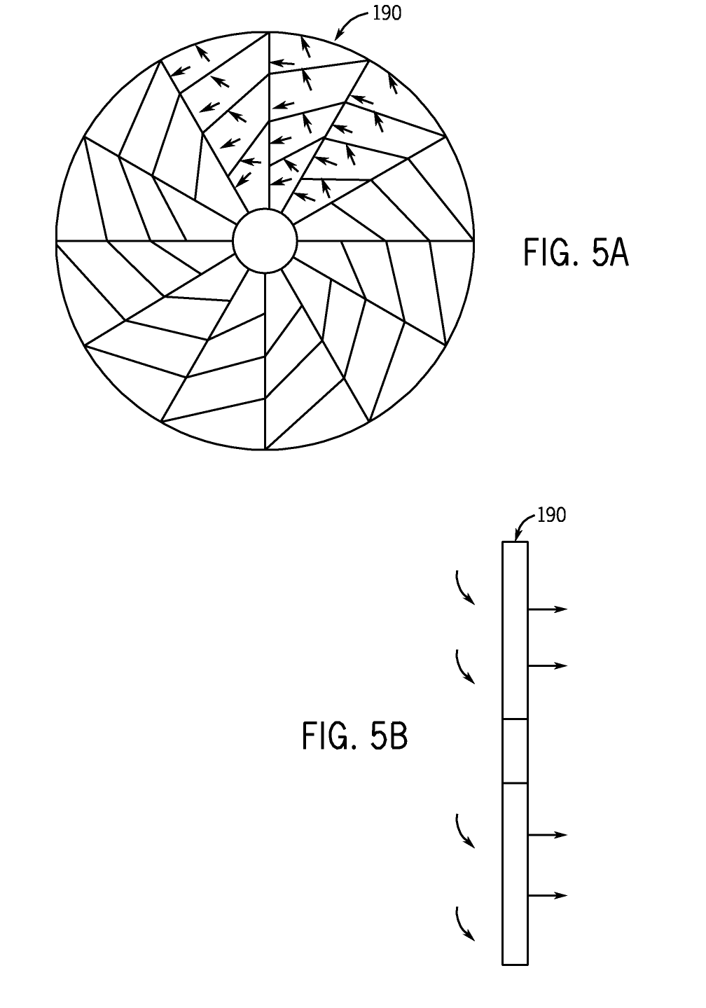

Turning to FIGS. 5a and 5b, a new designed axial converter 190 is shown that may be used for the second embodiment (FIG. 3) and the third embodiment (FIG. 4) of the invention. The width of the axial converter 190 must be adapted to the characteristics of the gas stream (e.g, pressure and velocity) that is to be straightened. It goes without saying that a gas stream having more pressure and more velocity needs more width to get fully straightened.

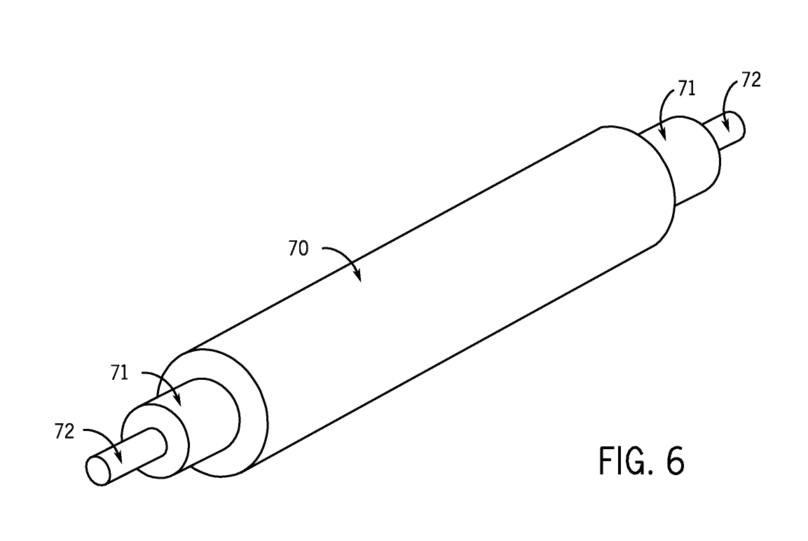

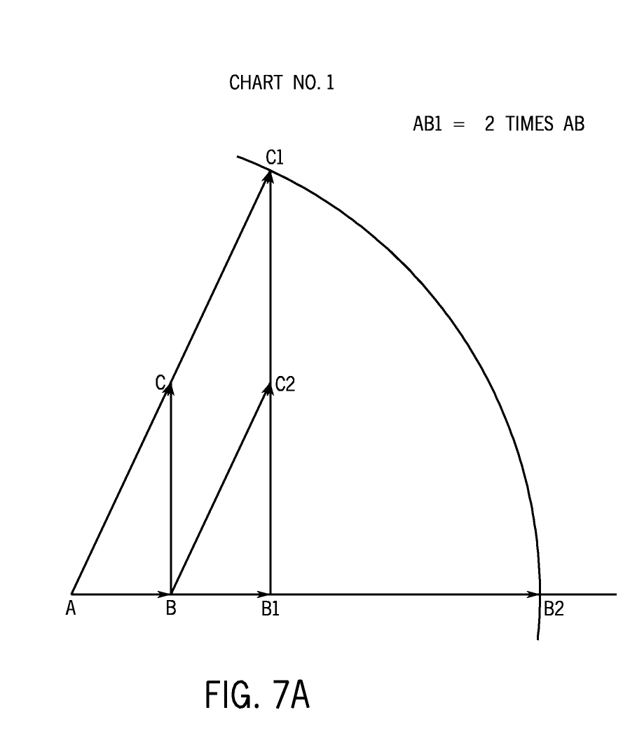

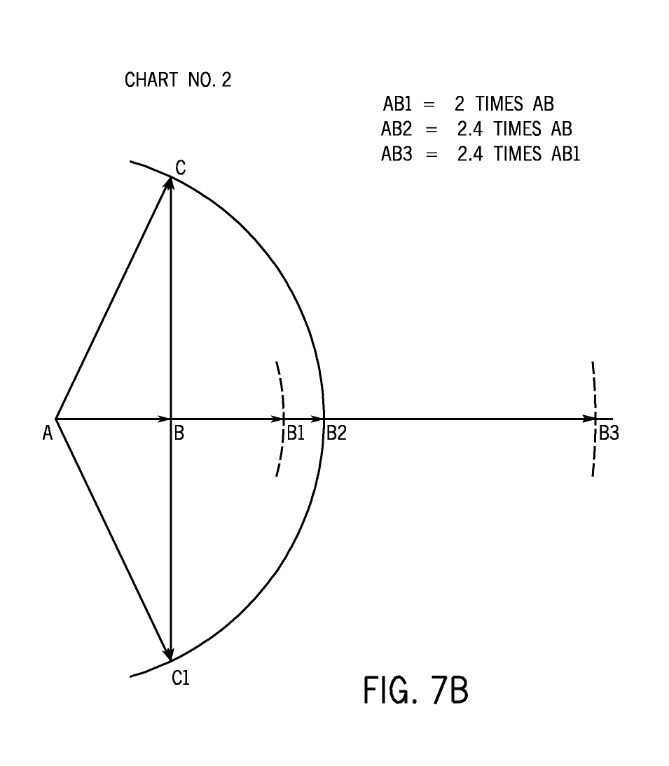

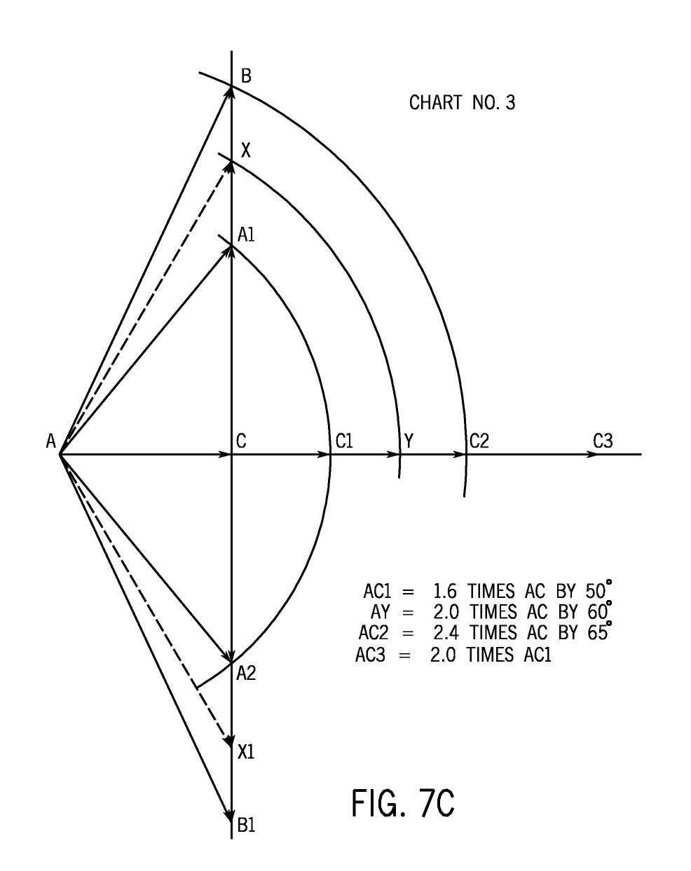

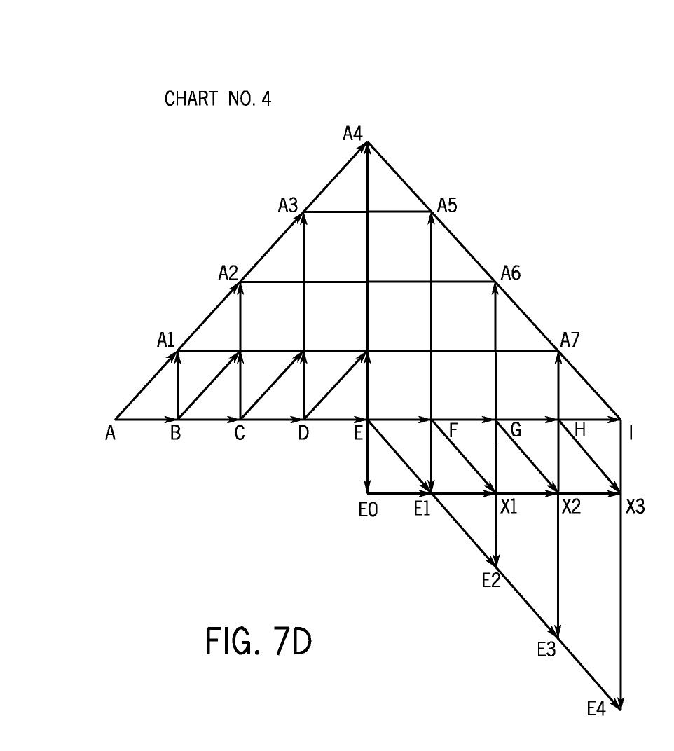

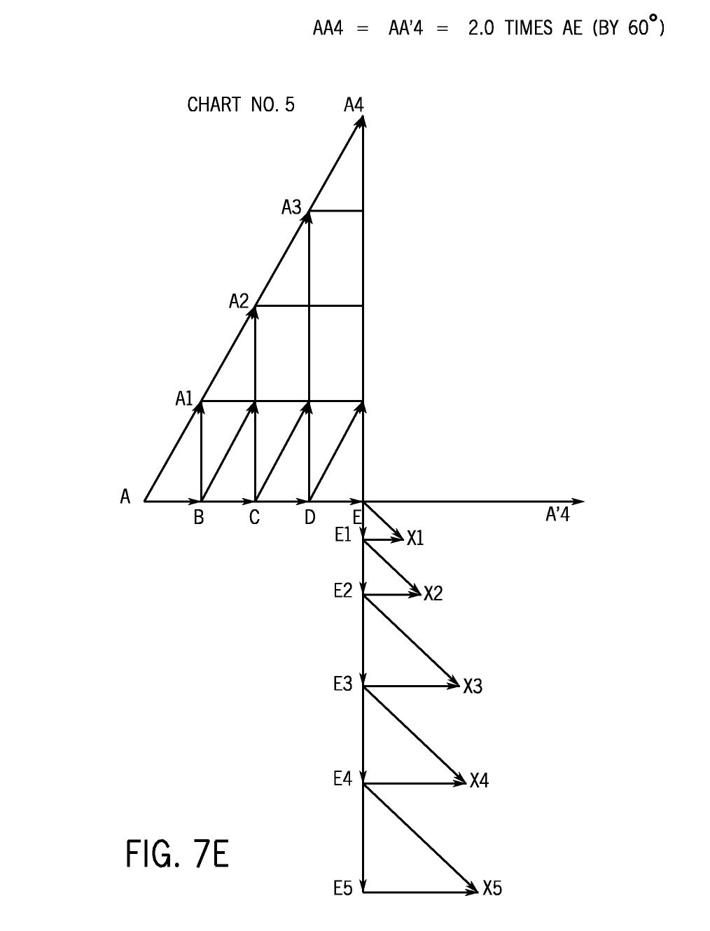

FIG. 6 shows two concentric shafts 72 and 71 with their protective covering 70. Bearings installed between the shafts 72, 71 and their cover 70 secure the rotation of the shafts 72 and 71 in one or the other direction.

Data Example of Two Particular Aero Turbo Engines

The performance of a compressor in accordance with the aspects of the invention is approximately 100% more than the performance of a compressor of a conventional aero turbo engine. Accordingly, the turbine of an aero turbo engine, according at least one aspect of the invention, may withdraw approximately only half the energy from the total thrust as compared to the withdrawal of energy from the turbine of a conventional aero turbo engine for driving the compressor by the same performance.

According to a study of comparison between the thrust values and the weights of several modern aero turbo engines, the total thrust of the gases leaving the combustion chamber is roughly proportional to the weight of a conventional aero turbo engine. One KN of the total thrust is realized by approximately a weight of 9.5 Kg of an engine.

The fuel consumption of an aero turbo engine is directly proportional to the air mass flow entering the combustion chamber respectively to the total thrust produced by the combustion chamber.

For example:

(a) Data of a conventional aero turbo engine with a maximum effective thrust of 300 KN by a withdrawal of energy of 50% from the turbine for the compressor:
Total thrust leaving the combustion chamber: 600 KN
Energy withdrawn from the turbine for the compressor: 300 KN
Effective thrust left for the flights: 300 KN
Approximate weight of the engine: 300 KN×9.5=5700 Kg
Approximate fuel consumption per 100 KN: 600×100/300=200 units

(b) Data of an aero turbo engine according to the present invention with a maximum effective thrust of 300 KN by a withdrawal of energy of 25% from the turbine for the compressor:
Total thrust leaving the combustion chamber: 400 KN
Energy withdrawn from the turbine for the compressor: 100 KN
Effective thrust left for the flight: 300 KN
Approximate weight of engine: 400×9.5=3800 Kg
Approximate fuel consumption per 100 KN: 400×100/300=133 units

(c) Reduction of weight between the engines (a) and (b):

(5700−3800)×100/5700: 33%

(d) Reduction of fuel consumption between the engines (a) and (b):

(200−133)×100/200: 33%

(e) Data of a conventional aero turbo engine with a maximum effective thrust of 240 KN by a withdrawal of energy of 60% from the turbine for the compressor:
Total thrust leaving the combustion chamber: 600 KN
Energy withdrawal from the turbine for the compressor: 360 KN
Effective thrust left for the flight: 240 KN
Approximate weight of the engine: 600×9.5=5700 Kg
Approximate fuel consumption for 100 KN: 600×100/240=250 units

(f) Data of an aero turbo engine according to the present invention with a maximum effective thrust of 240 KN by a withdrawal of energy of 30% from the turbine for the compressor:
Total thrust leaving the combustion chamber: 343 KN
Energy withdrawal from the turbine for the compressor: 103 KN
Effective thrust left for the flight: 240 KN
Approximate weight of the engine: 343×9.5=3259 Kg
Approximate fuel consumption for 100 KN: 343×100/240=143 units

Reduction of weight between the engine (e) and (f):

(5700−3259)×100/5700: 43%

Reduction of fuel consumption:

(250−143)×100/250: 43%

While aspects of the invention have been described with the respect to the physical embodiments constructed in accordance therewith, it will be apparent to those skilled in the art that various modification, variations, and improvements of the example embodiments may be made in the light of the above teachings and with the purview of the appended claims without departing from the intended scope of the invention. In addition, those areas in which it is believed that those of ordinary skill in the art are familiar have not been described herewith in order not to unnecessarily obscure the claimed invention. Accordingly, it is to be understood that the invention is not be limited by the specific illustrative embodiments, but only by the scope of the claims.

I claim:

1. A gas turbine engine, comprising:
a compressor, a combustion chamber, and a turbine arranged one after the other in the direction of the air mass flow;
wherein the compressor comprises:
a first compressor group having blade wheels rotating in a first compressor direction; and
a second compressor group having blade wheels located downstream of the first compressor group rotating in a second compressor direction opposite to the first compressor direction such that a deviation of the performance defined as air mass flow per second between both compressor groups is minimized and a detachment of the air mass flow from blades of a first smaller blade wheel of the second compressor group is substantially eliminated;
wherein the blade wheels of the second compressor group begin by the first smaller blade wheel and get progressively bigger in size to allow a bypass for the air mass flow coming from the first compressor group to serve the blade wheels of the second compressor group substantially simultaneously.

2. The gas turbine engine of claim 1, wherein:
the first compressor group comprises a plurality of blade wheels having essentially the same size of a diameter; and
the second compressor group comprises:
the first smaller blade wheel having a diameter of approximately 86% of the diameter of the blade wheels of the first compressor group;
a second blade wheel having a diameter of approximately 89% of the diameter of the blade wheels of the first compressor group;
a third blade wheel having a diameter of approximately 90% of the diameter of the blade wheels of the first compressor group;
a fourth blade wheel having a diameter of approximately 91% of the diameter of the blade wheels of the first compressor group; and
a fifth blade wheel having approximately the same diameter as the blade wheels of the first compressor group.

3. The gas turbine engine of claim 1, wherein:
the second compressor group comprises preferably five blade wheels of different sizes, starting with a smallest size of a diameter and continuing in a downstream direction with progressively bigger sizes of the diameter; and
except for the last blade wheel of the second compressor group, all of the other blade wheels are covered by conical rings that allow higher pressures of the blade wheels and a better distribution of the air mass flow between all of the blade wheels of the second compressor group.

4. The gas turbine engine of claim 3, wherein angles of at least one of the blade wheels of at least one of the first compressor group and the second compressor group are adjustable for an operation of the compressor by technically the highest possible angle between a helicoidal air mass flow and an axle of the compressor for obtaining a substantially highest possible performance of the compressor by the process of straightening the helicoidal air mass flow to an axial flow.

5. The gas turbine engine of claim 4, wherein:
the performance of a blade wheel can be calculated by the formula: air mass flow=(diameter of the blade wheels)³;
the performance of a group of compressor blade wheels is substantially the sum of the performances of each blade wheel; and
the rotation of the first compressor group in the first compressor direction and the second compressor group in the second compressor group is opposite to each other by approximately the same performance to substantially reduce the turbulences in the air mass flow.

6. The gas turbine of claim 1, wherein a reverse mechanism is installed between both compressor groups that inverses the rotational movement of the second compressor group to drive the first compressor group in an opposite direction to the second compressor group that is connected to the turbine by a shaft.

7. The gas turbine of claim 1, wherein both compressor groups are connected to two inversely rotating groups in opposite directions of the turbine by two concentric shafts that transmit the energy needed by the compressor from the turbine to the compressor.

8. The gas turbine engine of claim 7, wherein a diameter of blade wheels of a first group of the turbine is smaller than a diameter of blade wheels of a second group of the turbine so that the first group of the turbine withdraws less energy from the gas stream.

9. The gas turbine engine of claim 8, wherein an axial converter is installed downstream of the blade wheels of the first group of the turbine to straighten a helicoidal streaming of the gas produced in the first group of the turbine.

10. The gas turbine engine of claim 9, wherein a steel tube covers the first group of the turbine comprising the shorter blade wheels followed by the axial converter allowing a bypass for the gas flow coming directly from the combustion chamber.

11. The gas turbine engine of claim 1, wherein angles of at least some of the blade wheels may be adjustable to allow finding the best angles for the operation of the gas turbine engine during the tests for tuning.

12. The gas turbine engine of claim 1, wherein an intensity of a withdrawal of energy from the turbine is determined by connecting a measuring instrument at a free extremity of a shaft proximate the compressor side by letting the turbine blade wheels withdraw energy from a hot stream of gases by operating conditions.

13. The gas turbine engine of claim 1 including a shaft for driving an external rotating device.

14. The gas turbine engine of claim 13, wherein the rotating device is driving at least one of a pump, a rotor of a helicopter, a propeller of a turboprop aircraft, a water vehicle, a propeller of a hovercraft, an earth bound heavy vehicle, a tank, a locomotive, a pump for fuel or gas pipelines, and a generator for electricity production.

15. The gas turbine engine of claim 1, wherein the gas turbine engine comprise an aero turbo engine adapted to the turbine so that hot gases stream out of the aero turbo engine for propulsion of an aircraft.

16. A gas turbine engine for directing an air mass flow, comprising:
a compressor;
a combustion chamber downstream of the compressor; and
a turbine downstream of the combustion chamber;
wherein the compressor comprises:
a first group of compressor blade wheels rotating in a first compressor direction; and
a second group of compressor blade wheels positioned downstream of the first group of compressor blade wheels and rotating in a second compressor direction that is opposite to the first compressor direction;
wherein the second group of compressor blade wheels comprises:
a first blade wheel defining a first diameter; and
a second blade wheel positioned downstream of the first blade wheel defining a second diameter larger than the first diameter.

17. The gas turbine engine of claim 16, wherein the second group of compressor blade wheels further comprises a plurality of blade wheels positioned downstream of the second blade wheel defining a plurality of progressively increasing diameters.

18. The gas turbine engine of claim 16, wherein:
the first group of compressor blade wheels comprises a plurality of blade wheels and each of the plurality of blade wheels defines a first group diameter, wherein the first group diameter of each of the plurality of blade wheels is substantially similar;
the first diameter of the first blade wheel is approximately 86% of the first group diameter;
the second diameter of the second blade wheel is approximately 89% of the first group diameter; and
wherein the second group of compressor blade wheels further comprises:
a third blade wheel positioned downstream of the second blade wheel and defining a third diameter approximately 90% of the first group diameter;
a fourth blade wheel positioned downstream of the third blade wheel and defining a fourth diameter approximately 91% of the first group diameter; and
a fifth blade wheel positioned downstream of the fourth blade wheel and defining a fifth diameter approximately equal to the first group diameter.

19. The gas turbine engine of claim 16, wherein the turbine comprises:
a first group of turbine blade wheels defining a first turbine diameter;
a second group of turbine blade wheels positioned downstream of the first group of turbine blade wheels defining a second turbine diameter; and
an axial converter positioned downstream of the first group of turbine blade wheels and upstream of the second group of turbine blade wheels;
wherein the first turbine diameter is less than the second turbine diameter.

20. A method of manufacturing a gas turbine engine, comprising:
providing a first group of compressor blade wheels;
calculating a performance of each blade wheel in the first group of compressor blade wheels with the formula: air mass flow=(diameter of the blade wheel)³
calculating a performance of the first group of compressor blade wheels by summing the performances of each blade wheel in the first group of compressor blade wheels;
providing a second group of compressor blade wheels;
calculating a performance of each blade wheel in the second group of compressor blade wheels with the formula: air mass flow=(diameter of the blade wheel)³
calculating a performance of the second group of compressor blade wheels by summing the performances of each blade wheel in the second group of compressor blade wheels; and
configuring the first group of compressor blade wheels and the second group of compressor blade wheels such that the rotation of the first group of compressor blade wheels is opposite to the rotation of the second group of compressor blade wheels to approximately offset the performance of the first group of compressor blade wheels and the second group of compressor blade wheels and thereby substantially reduce any turbulences in an air mass flow through the gas turbine engine.
